(19) United States
(12) Patent Application Publication
(10) Pub. No.: US 2012/0207852 A1
(43) Pub. Date: Aug. 16, 2012

(54) Biocide compositions and related methods

(76) Inventor: Roy W. Martin, Downers Grove, IL (US)

(21) Appl. No.: 12/932,469

(22) Filed: Feb. 25, 2011

Related U.S. Application Data
(63) Continuation-in-part of application No. 12/931,896, filed on Feb. 14, 2011.

(51) Int. Cl. A01N 59/00; A01P 1/00

(52) U.S. Cl. 424/616; 424/613

(57) ABSTRACT

Compositions for producing a biocide solution upon contact with water, the composition comprises at least an acid anhydride and polyoxychlorine donor. The biocide solution forms reactive oxygen species that releases oxygen gas when contacted by microorganisms, proteinaceous substances, and oxidizable organic based contaminants. The biocide solution is free of chlorine dioxide.

### FIELD OF INVENTION

The present invention relates to biocides and methods for killing microorganisms.

### BACKGROUND

Oxidizing biocides are commonly used for the treatment of recirculating systems such as industrial cooling systems and swimming pools, disinfecting hard surfaces, sanitizing food product surfaces, food processing equipment, and sterilizing surgical instruments.

Chlorine dioxide is an oxychlorine compound that is an effective oxidizing biocide that is currently approved for use in these types of application.

In order to obtain sporicidal registration through the U.S. EPA and FDA, meeting the requirements of AOAC method 966.04 is necessary. The AOAC method 966.04 is considered to be one of the most, if not the most difficult test to meet due to the nature of the test. C. Sporogenes and B. Subtilis spores are affixed to ceramic cylinders in a proteinaceous and soil based matrix. This matrix is difficult to penetrate and as a result, otherwise extremely effective biocides such as chlorine dioxide can require as much as 1 hour or more of contact time with 1000 ppm as ClO₂ to meet the requirements for being sporicidal using AOAC method 966.04.

Furthermore, at such high concentrations of ClO₂ needed to meet the criteria for being regarded as a sporicidal, the high volatility of chlorine dioxide can be a significant issue and health concern.

There is a need for a fast acting oxychlorine based biocide composition that can provide the benefits of chlorine dioxide without its limitations, while improving penetration of biofilms, proteinaceous deposits and accelerate inactivation of mycobacterium, spores, and oocyst at an accelerated rate.

U.S. Pat. No. 6,866,870 (“870”) discloses a biocide composition formed from ingredients comprising peroxide and a hypochlorite, wherein the biocide composition is formed by adding the peroxide ingredient to the hypochlorite ingredient so that the weight ratio of the hypochlorite to the peroxide is in the range of about 10:1 to 100:1.

The “870” patent is very limited in that: the peroxide ingredient must be added to the hypochlorite ingredient in a specific sequence; the method of producing the biocide composition requires a two-component system (bi-component); the biocide composition cannot be a solid composition; and the weight ratio of hypochlorite to peroxide must be at least 10:1, and the method of producing a biocide composition must be carried out in essentially the absence of organic matter, thereby eliminating the use of organic acids, anhydrides, surfactants and the like.

U.S. Patent Application No. 2011/0014276 A1 discloses an antimicrobial preservative for use in an ophthalmic product, the preservative comprising from about 0.005 wt. % to about 0.20 wt. % chlorite compound and from about 0.005 wt. % to about 0.05 wt. % peroxy compound, wherein the preservative does not generate chlorine dioxide, and wherein the preservative is at a pH range between about 6.0 and about 8.8.

U.S. Pat. No. 2,482,891 discloses a solid composition comprising an acid anhydride and alkali and alkali earth metal chlorite for producing chlorine dioxide.

### SUMMARY OF THE INVENTION

The present invention is deemed to meet this and other needs in a unique and highly facile way.

Acid anhydrides have been used in producing chlorine dioxide as an acidulent or in direct reaction with alkali and earth alkali chlorites. Alkali and earth alkali chlorates have been used to produce chlorine dioxide by reduction of chlorates in strong acid solutions.

It has been discovered that extremely effective biocide solutions and bleaching solutions are produced when an acid anhydride and a polyoxychlorine anion donor comprising at least one polyoxychlorine anion having from 3 moles to 4 moles of oxygen reported as elemental oxygen are combined with water. The resulting biocide solutions are free of chlorine dioxide unless an alkali and/or alkali earth metal chlorite is included with the composition.

The biocide and bleaching solutions resulting from the compositions of the invention were unexpectedly far more effective than solutions containing 10× the concentration of the same polyoxychlorine anion donor used in the composition. Furthermore in at least one instance, it was shown that a ceramic cylinder test solution having a total oxidizer concentration 28× higher was inferior to the test solution resulting from the composition of the invention.

Further still, it was discovered that reducing the molar ratio of polyoxychlorine donors to acid anhydride increased the activity of the biocide and bleach solutions. Biocide and bleaching solution resulting from compositions of the invention having only 20 wt % of the same polyoxychlorine anion donor had substantially higher reactivity with the spore laden proteinaceous deposits on the ceramic cylinders. This finding is counterintuitive to what was expected. Intuitively, higher concentrations of the same oxidant would be expected to be more active and reactive with the deposits. When combined with the acid anhydride however, the opposite was found to be the case. The molar ratio of acid anhydride to polyoxychlorine anion donor was found to be more relevant to reactivity than concentration of the oxidant or total amount of oxidants in the final solutions. These results indicate there is a synergistic effect resulting from combining polyoxychlorine anion donors having 3 moles and 4 moles of oxygen reported as elemental oxygen with an acid anhydride. Unlike acid anhydride reaction with chlorite (2 moles of oxygen) which results in conversion of ClO₂⁻ anion to ClO₂, the resulting biocide and bleach solutions of the compositions of the invention provides for formation of reactive oxygen species. Reaction of the reactive oxygen species results in liberation of oxygen gas without formation of chlorine dioxide.

In one embodiment of the invention, there is provided a composition for producing a biocide solution, the composition comprising an acid anhydride and a polyoxychlorine anion donor comprising at least one polyoxychlorine anion having from 3 moles to 4 moles of oxygen reported as elemental oxygen, wherein the biocide solution is formed by adding the acid anhydride and polyoxychlorine donor to an aqueous solution so that the molar ratio of the acid anhydride to polyoxychlorine anion is about 25:1 to 1:10, more preferably 15:1 to 1:5, and most preferably 10:1 to 1:2.

The composition of the invention allows for a biocide solution using peroxychlorine anion donors having 3 moles and 4 moles of oxygen measured as elemental oxygen without the formation of chlorine dioxide. However, the addition of a polyoxychlorine anion having 2 moles of oxygen (chlorite) reported as elemental oxygen allows for the formation of a biocide solution with at least some proportion of chlorine dioxide.

In another embodiment of the invention, there is provided a composition for producing a bleaching solution, the composition comprising an acid anhydride and a polyoxychlorine anion donor comprising at least one polyoxychlorine anion having from 3 moles to 4 moles of oxygen reported as elemental oxygen, wherein the bleaching solution is formed by adding the acid anhydride and polyoxychlorine donor to an aqueous solution so that the molar ratio of the acid anhydride to polyoxychlorine anion is about 25:1 to 1:10, more preferably 15:1 to 1:5 and most preferably 10:1 to 1:2.

In another embodiment of the invention, there is provided a biocide solution comprising water, and at least a 0.5 wt % of a composition comprising an acid anhydride and a polyoxychlorine anion donor comprising at least one polyoxychlorine anion having from 3 moles to 4 moles of oxygen reported as elemental oxygen, wherein the bleaching solution is formed by adding the acid anhydride and polyoxychlorine donor to an aqueous solution so that the molar ratio of the acid anhydride to polyoxychlorine anion is about 25:1 to 1:10, more preferably 15:1 to 1:5 and most preferably 10:1 to 1:2. The biocide solution may be stored for extended periods of time by buffering the pH to below 6.0 until it is to be made ready for use, or until it is diluted thereby resulting in an increase in pH.

In another embodiment of the invention, a method is provided which comprises contacting a microorganism with a biocidally effective amount of a biocide solution according to this invention.

### DETAILED DESCRIPTION OF THE EMBODIMENT(S)

It has been discovered that combining an alkali metal salt of polyoxychlorine anions having from 3 moles to 4 moles of oxygen reported as elemental oxygen with an acid anhydride results in the formation of a biocide solution with substantially enhanced utility and ability to penetrate proteinaceous deposits and biofilms.

The use of the said polyoxychlorine anions with acid anhydride results in a biocide and bleaching solutions with excellent stability until such time the solution contacts microorganisms, proteinaceous deposits and suspensions and oxidizable organics. The compositions of the invention and their respective biocide and bleaching solutions demonstrate excellent compatibility with many organic acids, acid anhydrides, and surfactants such a block copolymers exemplified by Pluronic 31R1. This greatly expands their use in formulations and applications where detergency, increased wetting, and dispersants are beneficial.

Furthermore, the use of polyoxychlorine anion donors with acid anhydrides greatly increases the oxidative activity of the biocide solution produced. It has been discovered that the oxidative activity is increased as the moles of oxygen bound to the anion portion of the polyoxychlorine anion donor increases when combined with acid anhydride. Unexpectedly, the biocide solutions comprising polyoxychlorine anions having higher molar levels of oxygen demonstrate improved storage stability until such time as they contact an oxidizable substance, at which time they demonstrate more aggressive decomposition.

Furthermore, the biocide and bleaching solutions resulting from polyoxychlorine anions having 3 moles (chlorates) and 4 moles (perchlorates) of oxygen bound to the anion portion of the polyoxychlorine anion donor is free of chlorine dioxide. There is no indication of chlorine dioxide in the resulting solution even with relatively high concentrations of ingredients comprising greater than 2 wt % of the solution.

The compositions of the invention can comprise a solid composition. The solid compositions may be in the form of a powder, granules and tablet. The solid compositions may comprise a mixture of all ingredients, or may comprise two or more solids that are separated and can be premixed prior to addition to water, or added separately to water to form the biocide solution. The compositions of the invention may also include liquids or combinations of solids and liquids.

As used herein, the term “water” includes aqueous solutions that comprise water. The use of the term water is not to imply the water is pure or removed of all mineral salts and gases common to most waters.

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems such as cooling towers and cooling ponds, swimming pools, fountains and feature pools.

As used herein “food processing applications” include those aspects within the process that utilize antimicrobial treatments to reduce the potential of spread of infectious disease. Applications include: vegetable and fruit washing; cleaning and sanitizing of food processing equipment; cleaning and sanitizing of animal carcasses, poultry, meat, rabbit, and egg products, treatment of poultry and animal habitats.

As used herein, “food product surfaces” include: meat carcasses of beef, pork, poultry, and fish; fruit surfaces, and vegetable surfaces.

As used herein, “hard surfaces” include: countertops; floors; walls; tables; cabinets; doors; doorknobs; food processing equipment, and the like.

As used herein, “surgical instruments” include: endoscopes; scalpels; forceps, and other instruments that require sterilization.

As used herein, “acid donor” describes compounds that contribute hydrogen ions (H⁺) when dissolved in water. Acid donors can be inorganic and organic. Specific non-limiting examples of inorganic acid donors include but are not limited to sodium bisulfate, potassium bisulfate, sodium pyrosulfate, and potassium pyrosulfate. Specific non-limiting examples of organic acid donors include maleic acid, malonic acid, fumaric acid, succinic acid, tartaric acid. Non-reducible organic acid donors are preferred.

As used herein, “acid anhydride” describes compounds two acyl groups bound to the same oxygen atom. Specific non-limiting examples of acid anhydrides include but are not be limited to succinic anhydride, maleic anhydride, N-caprylic anhydride, acetic anhydride, and the like.

As used herein, “polyoxychlorine anion donor” is selected from an alkali and alkali earth metal chlorate (ClO₃⁻), and alkali and alkali earth metal perchlorate (ClO₄⁻). Specific non-limiting examples include but are not be limited to: sodium chlorate, potassium chlorate, magnesium chlorate, calcium chlorate, sodium perchlorate, potassium perchlorate, magnesium perchlorate, calcium perchlorate.

As used herein, “polyoxychlorine anion having from 3 moles to 4 moles of oxygen reported as elemental oxygen” describes the number of moles of oxygen reported as elemental oxygen in the anion portion of the polyoxychlorine anion donor. For example, the polyoxychlorine anion donor sodium chlorate having the general formula NaClO₃ comprises the polyoxychlorine anion ClO₃⁻ which has three moles of oxygen reported as elemental oxygen.

As used herein, “persulfate donor” includes ammonium and alkali persulfates. Specific non-limiting examples include: ammonium persulfate, sodium persulfate, potassium persulfate, and potassium monopersulfate.

As used herein, “hydrogen peroxide donor” describes a source of hydrogen peroxide having the general formula H₂O₂. Hydrogen peroxide donors useful in the practice of this invention include hydrogen peroxide, alkali and alkali earth metal peroxides as well as other metal peroxides. Specific non-limiting examples include sodium perborate, sodium percarbonate, calcium peroxide, magnesium peroxide, sodium peroxide, potassium peroxide, and the like, and aqueous solutions comprising percarboxylic acid exemplified by peracetic acid, persuccinic acid, and peroctanoic acid.

As used herein, “alkalinity donor” consumes hydrogen ions, thereby inducing an increase in the pH of the biocide solution and bleaching solution resulting from the compositions of the invention being contacted with water. Alkalinity donors are selected from alkali and alkali earth metals of bicarbonate, alkali and alkali earth metals of carbonate, alkali and alkali earth metals of phosphate, alkali and alkali earth metals of borate. Specific non-limiting examples include sodium bicarbonate, potassium bicarbonate, sodium carbonate, potassium carbonate, disodium phosphate, trisodium phosphate, sodium borate and the like.

As used herein, “percarboxylic acid donor” describes ingredients for either in-situ generation of percarboxylic acid or an ex-situ source of percarboxylic acid. Ingredients for in-situ generation of percarboxylic acid include an acid anhydride exemplified by but not limited to succinic anhydride and maleic anhydride, and a hydrogen peroxide donor exemplified by but not limited to hydrogen peroxide, sodium percarbonate, and sodium peroxide. The ex-situ source of percarboxylic acid is a ready-made solution comprising percarboxylic acid. Examples include but are not limited to persuccinic acid, peracetic acid, permaleic acid, and peroctanoic acid.

As used herein, “reactive oxygen species” are any combination or variants of oxygen and oxygen radicals that are effective oxidizers. Specific non-limiting examples of reactive oxygen species include but are not limited to singlet oxygen, superoxide, and hydroxyl radicals.

As used herein, “biocide solution” describes an aqueous solution comprising the compositions of the invention. The compositions of the invention and resulting biocide solutions can be optimized to meet the requirements to be classified as a disinfectant, sanitizer, and/or sterilant.

As used herein, “bleaching solution” describes an aqueous solution comprising the composition of the invention for use in applications wherein the oxidation of organic based compounds is desired. Specific non-limiting examples of applications for bleaching solutions include: laundry, dishwashing, hard surface cleaning, swimming pools, denture cleaning, carpet cleaning, and the like.

As used herein, “proteinaceous” describes any of a group of complex organic macromolecules that contain carbon, hydrogen, oxygen, nitrogen, and usually sulfur and are composed of one or more chains of amino acids. Proteins are fundamental components of all living cells and include many substances, such as enzymes, hormones, and antibodies that are necessary for the proper functioning of an organism.

As used herein, “organic based contaminants” are carbon based compounds that can be at least partially oxidized by reactive oxygen species.

As used herein, “weight percent” and “wt %” unless otherwise stated is based on the total weight of the biocide solution.

As used herein, “effective amount of combustion suppressing boron donor” defines an effective amount of boron containing compound exemplified by borax and boric acid that can reduce the combustion rate of the solid composition to a packing group having lower transportation and/or storage restrictions. Division 5.1 Oxidizer Testing in accordance with the Code of Federal Regulations, Title 49, and the United Nations Transportation of Dangerous Goods—Manual of Test and Criteria, Fourth revised edition (2003). Solid Division 5.1 materials are assigned packing groups using the following criteria [49 CFR .sctn.173.127(b)]: (i) Packing Group I is the sub-classification of any material which, in the 4:1 or 1:1 sample to cellulose ratio (by mass) tested exhibits a mean burning time less than the mean burning time of a 3:2 mixture, by mass, of potassium bromate and cellulose. (ii) Packing Group II is the sub-classification of any material which, in the 4:1 or 1:1 sample to cellulose ratio (by mass) tested exhibits a mean burning time less than the mean burning time of a 2:3 mixture, by mass, of potassium bromate and cellulose, and the criteria for Packing Group I are not met. (iii) Packing Group III is the sub-classification of any material which, in the 4:1 or 1:1 sample to cellulose ratio (by mass) tested exhibits a mean burning time less than the mean burning time of a 3:7 mixture, by mass, of potassium bromate and cellulose, and the criteria for Packing Groups I and II are not met.

As used herein, the term “tablet” refers to any geometric shape or size that comprises at least the ingredients of the compositions of the invention. The ingredients of the composition are agglomerated into a single mass to form a tablet. The tablet, upon contact with water produces a biocide solution.

As used herein, the term “multi-tablet chemical dispenser” describes any convenient feed system that holds multiple tablets of the invention and contacts at least some portion of the tablets with an aqueous solution to produce a solution consisting of at least chlorine dioxide. Examples include flow-thru brominators such as those sold by Great Lakes Water Treatment, Nalco Chemical, and BetzDearborn Inc. whose disperser is exemplified in U.S. Pat. No. 5,620,671, spray feeders like those sold by Arch Chemical and sold under the trade name Pulsar, floating dispensers, or a perforated dispenser such as a minnow bucket or strainer that is immersed into the aqueous solution.

As used herein, the term “bulk packaging” defines the ability to package a plurality of tablets into one package without segregating each tablet. Example packaging includes but is not limited to plastic bags and/or plastic pails. Bulk packaging requires the tablet possess sufficient environmental and chemical stability as to substantially eliminate the potential for formation of chlorine dioxide during packaging, storage and transport.

Hydrogen peroxide donors useful in the practice of this invention include hydrogen peroxide, alkali and alkali earth metal peroxides as well as other metal peroxides. Specific non-limiting examples include sodium perborate, sodium percarbonate, calcium peroxide, magnesium peroxide, sodium peroxide, potassium peroxide, and the like.

Polyoxychlorine anion donors useful in the practice of the invention include alkali metal and alkali earth salts of chlorate, and perchlorate. Specific non-limiting examples include sodium chlorate, potassium chlorate, magnesium chlorate, calcium chlorate, sodium perchlorate, potassium perchlorate, magnesium perchlorate, calcium perchlorate.

Alkalinity donors consume hydrogen ions, thereby inducing an increase in the pH of the biocide solution and bleaching solution resulting from the compositions of the invention being contacted with water. Specific non-limiting examples include sodium bicarbonate, potassium bicarbonate, sodium carbonate, potassium carbonate, disodium phosphate, trisodium phosphate, sodium borate and the like.

Acid donors can be inorganic and organic. Specific non-limiting examples of inorganic acid donors include but are not limited to sodium bisulfate, potassium bisulfate, sodium pyrosulfate, and potassium pyrosulfate. Specific non-limiting examples of organic acid donors include maleic acid, malonic acid, fumaric acid, succinic acid, tartaric acid. Non-reducible organic acid donors are preferred.

Acid anhydrides suitable for use in this invention are those that react with the polyoxychlorine anion when the composition is contacted with water to produce at least one of a biocide solution and bleach solution. Specific non-limiting examples of acid anhydrides include but are not be limited to succinic anhydride, maleic anhydride, N-caprylic anhydride, acetic anhydride.

Solid compositions of this invention may be in the form of powders, granules, and tablets. Solid composition may be packaged as a single composition, or as separate ingredients to be later mixed then added to water or individually added to water.

Solid compositions in the form of a tablet can be formed into a biocide solution using a multi-tablet chemical dispenser for ease of producing the biocide solution for higher use applications such as cooling towers and swimming pools. Tablets can also be packaged using bulk packaging.

Solid compositions in the form of granules and powders maybe dissolved in water then fed thru a chemical pump, fed thru a shot feeder wherein the solid composition is placed into a vessel, the vessel is sealed, and water is piped into the vessel to dissolve the composition, form the biocide solution, and dispense the biocide solution to the aqueous system to be treated such as a cooling tower, swimming pool, spa, and the like.

Solid compositions may be packaged in single use packages for producing a biocide solution for disinfection hard surface such as counter tops, doorknobs, cabinets, and the like.

Additionally, solid compositions may be packaged in single use packages can be used for producing a sterilant for use in hospitals and emergency medical units such as military field hospitals.

Solid compositions can also be packaged as bleaches for laundry or formulated with dry or non-aqueous laundry detergents.

Further still, solid compositions can be used to produce biocide solutions for the treatment of food product surfaces such as carcasses of beef, pork, poultry and fish products.

Solid compositions can also be used to disinfect food processing equipment and animal habitats.

Compositions can also comprise liquids, and/or liquids and solids to produce the biocide solution. A biocide solution can be prepared by adding liquid ingredients or liquid and solid ingredients to produce a biocide solution comprising a weight percent of ingredients of about 0.5 wt %. The ingredients and water should be mixed to form a homogenous solution. The resulting biocide solution can be diluted with water prior to use.

Compositions of the invention can be formed into a biocide solution using any convenient means such as a chemical tank and mixer fitted with a chemical feed pump for treating applications such as cooling towers and swimming pools.

Compositions of the invention can be fed thru a shot feeder wherein the composition is placed into a vessel, the vessel is sealed, and water is piped into the vessel to dissolve the composition, form the biocide solution, and dispense the biocide solution to the aqueous system to be treated such as a cooling tower, swimming pool, spa, and the like.

Compositions of the invention may be packaged in single use packages for producing a biocide solution for disinfection hard surface such as counter tops, doorknobs, cabinets, and the like.

Additionally, compositions of the invention may be packaged in single use packages can be used for producing a sterilant for use in hospitals and emergency medical units such as military field hospitals.

Compositions of the invention can also be packaged as bleaches for laundry or formulated with laundry detergents.

Further still, compositions of the invention can be used to produce biocide solutions for the treatment of food product surfaces such as carcasses of beef, pork, poultry and fish products.

Compositions of the invention can also be used to produce biocide solutions for the treatment of food processing equipment and animal habitats.

Surfactants can be incorporated into the composition or the biocide solution to reduce the surface tension, improve wetting, improve detergency, and provide foaming capability. Specific non-limiting examples include block copolymer surfactants sold under the trade name Pluronic® manufactured by BASF.

Anti-caking agents can improve flowability and reduce clumping of dry compositions and ingredient. I can be advantageous to apply an anti-caking agent exemplified by magnesium carbonate light, untreated fumed silica and treated fumed silica. Fumed silica is sold under the trade name CAB-O-SIL® and is manufactured by Cabot Corporation. Anti-caking agents can also reduce the hygroscopic nature of the polyoxychlorine anion donors as well as the entire solid composition.

Dispersants such as tripolyphosphate can be useful in dispersing soils in sterilant and other applications in which the biocide solution must penetrate deposits to effectively inactivate microorganisms.

### Testing

AOAC method 966.04 is used to determine the sporicidal efficacy of an antimicrobial agent. The test uses ceramic cylinders that have been placed in a suspension of proteinaceous materials and soils which had been inoculated with Bacillus subtilis and C. Sporogenes. The coated cylinders are removed from the suspension and dried. This preparation embeds the spores in a heavily soiled proteinaceous matrix that protects the spores from the sporicide. The normally white ceramic cylinders acquire beige to tan color with some having brown areas due to heavier deposition.

Samples of the prepared ceramic cylinders where obtained from MicroChem laboratory Inc. of Euless, Tex.

All of the stock biocide solutions used in the test where prepared by mixing solid ingredients then adding the listed ingredients into 100 ml of water and mixing using a magnetic stirrer until clear and no suspended solids were observed. The activity of the biocide solution was tested by using the stock biocide solution as prepared, or by diluting the stock biocide solution, filling a vial to the 10 ml mark, then adding one of the prepared ceramic cylinders used for sporicidal testing. A stop watch was started when the ceramic cylinder was added, and observations were made to assess the speed and aggressiveness of the reaction by observing the rate at which gas was formed on the cylinder, the relative amount of gas released, the time lapsed until the gas formation terminated, and the color of the ceramic cylinder upon completion of either the termination of gas formation or termination of the test.

TABLE 1

| | Sodium | Magnesium | Succinic | Alkalinity | Observation |
|---|---|---|---|---|---|
| SAMPLE | Chlorate | Perchlorate | Anhydride | NaHCO₃ | Ceramic Cylinder test |
| #1ClO3 | 2.0 gm | na | 1.0 gm | 1.0 gm | pH 6.01 of stock solution |
| | | | | | 2.5 ml stock soln + 7.5 ml water |
| | | | | | slow gas evolution initially |
| | | | | | increasing gas evolution |
| | | | | | completed in approx 10 |
| | | | | | minutes |
| #2ClO3 | 0.2 gm | na | 1.0 gm | 1.0 gm | pH 5.64 of stock soln. |
| | | | | | 5 ml stock soln. + 5 ml water |
| | | | | | Rapid evolution of gas |
| | | | | | completed in approx 2 |
| | | | | | minutes |
| #1ClO4 | na | 0.2 gm | 1.0 gm | 1.0 gm | pH 5.79 stock soln. |
| | | | | | 5 ml stock soln. + 5 ml water |
| | | | | | appears slower than #2ClO3 |
| | | | | | gas evolution completed 4 min. |

The results of table 1 unexpectedly showed as the molar ratio of acid anhydride to polyoxychlorine anion increased, the activity of the biocide and bleaching solution increased. In the ceramic cylinder test, the diluted solution identified as samples #2ClO3 having only 20% of the active oxidizer (sodium chlorate) compared to sample #1ClO3, yet the results showed the reactivity of #2ClO3 dramatically increased. The data shows that as the molar ratio of succinic anhydride to chlorate anion increased, the availability of reactive oxygen species increased even though the solution was 80% lower in chlorate. This is counterintuitive since the chlorate is the oxidizer component of the composition. Furthermore, the sample identified as #1ClO4 comprising magnesium perchlorate resulting from a stock solution having 0.2 grams of magnesium perchlorate was far more effective than the solution resulting from a stock solution having 2.0 grams of sodium chlorate. The result of these test shows that combining the sodium chlorate and magnesium perchlorate with succinic anhydride resulted in some form of intermediate that, when placed in contact with the ceramic cylinder, resulted in formation of reactive oxygen species and subsequent evolution of gas.

TABLE 2

| | | | | Succinic | | Ceramic Cylinder in |
|---|---|---|---|---|---|---|
| | NaClO₂ | NaClO₃ | Percarbonate | Acid | | 10 ml AOAC 966.04 |
| Sample | gm | gm | gm | gm | Sequence | 1 min. Observation |
| #1A | na | 0.71 gm | 2.10 gm | 2.00 gm | mixture | No relevant reaction |
| | | | | | | pH 5.72 |
| #2A | 1.10 gm | na | 2.10 gm | 2.00 gm | mixture | Slow reaction - |
| | | | | | | gas formation, |
| | | | | | | pH 5.75 |

The results of Table 2 illustrate under the conditions tested, the chlorate did not work synergistically with the sodium chlorate using succinic acid as the acid donor. However chlorite did induce a reaction in the presence of hydrogen peroxide with succinic acid as the acid donor. Results further show that combining the ingredients of sample #2A to form a mixture, and adding the mixture to water to provide approximately a 5 wt % solution, resulted in a slow but favorable decomposition of the proteinaceous deposit on the ceramic cylinder.

Furthermore, the results of Table 2 illustrate the spore laden proteinaceous deposit on the ceramic cylinder used in AOAC method 966.04 had no observable to slow reaction with the undiluted solutions comprised of various oxidants including polyoxychlorine anion donors of the invention. Furthermore, the concentrations of polyoxychlorine anion donor in the ceramic cylinder solution labeled #2A is greater than 10× higher than the test solutions labeled #2ClO3 and #1ClO4 illustrated in table 1, yet the results in table 2 are undesirable. Further still, the total amount of oxidant in the cylinder test solutions illustrated in table 2 are 28× higher than the total amount of oxidants in the cylinder test solutions of table 1 which comprise the composition of the invention. The comparison of the data from table 1 and table 2 clearly illustrated the dramatic improvements in efficacy resulting from the compositions of the invention.

Samples of biocide solutions were prepared by combining measured amounts ingredients illustrated in Table 3, then adding them to 100 ml of water while mixing using a magnetic stirrer.

TABLE 3

| | Sodium | Magnesium | Sodium | Succinic | | |
|---|---|---|---|---|---|---|
| Sample | Chlorate | Perchlorate | Percarbonate | Anhydride | Sequence | Observation |
| #5A | 1.00 gm | na | 2.00 gm | 1.50 gm | mixture | pH 6.77 |
| | | | | | | Aggressive reaction |
| | | | | | | 30 seconds |
| | | | | | | reaction complete |
| | | | | | | cylinder white |
| #6A | na | 1.00 gm | 2.00 gm | 1.50 gm | mixture | pH 6.73 |
| | | | | | | Aggressive reaction |
| | | | | | | 15-20 seconds |
| | | | | | | reaction complete |
| | | | | | | cylinder white |

The results unexpectedly illustrate that polyoxychlorine anion donors with 3 or more moles of oxygen in the presence of hydrogen peroxide and succinic anhydride provided a biocide solution with a high level of reactivity toward the spore laden proteinaceous deposits. The sample using magnesium perchlorate showed the potential for even more favorable results than the sodium chlorate sample. This may be due to the higher level of oxygen being liberated from the perchlorate. Furthermore, there was no indication of chlorine dioxide being generated in the biocide solution.

TABLE 4

| Sample | 24 hr | 48 hr |
|---|---|---|
| #5A | 2 ml soln to 8 ml water (0.90 wt % solids) | 2 ml soln to 8 ml water (0.90 wt % solids) |
| | bubble formation on surface | Same observations as 24 hr test |
| | evolution of gas - increased with | Activity remains high |
| | movement. 4.5 minutes cylinder | |
| | is white. No apparent gas formation | |
| #6A | 2 ml soln to 8 ml water (0.90 wt % solids) | 2 ml soln to 8 ml water (0.90 wt % solids) |
| | Readily forms gas with evolution | Comparable to 24 hr test. |
| | Reaction nears completion is 2 min. | Cylinder is white and gas formation |
| | cylinder white in appearance | completed in approx 2 minutes |

Table 4 comprises data from follow-up test for samples of biocide solution produced in support of the data in table 3. These tests illustrate the relative stability of the biocide solution after 24 hrs and 48 hours of storage. The biocide sample identified as #5A and #6A where diluted with fresh water to achieve approximately a 0.9 wt % solids (ingredients). The results unexpectedly show the samples remained highly active and imparted a strong reaction with the proteinaceous deposits on the ceramic cylinders. Furthermore, there was no indication of chlorine dioxide generation in the biocide solution.

TABLE 5

| Sample | Sodium | Succinic | | |
|---|---|---|---|---|
| Peracid | Percarbonate | Anhydride | Sequence | Observations |
| | 3.00 gm | 3.00 gm | mixture | pH 6.56 |
| | | | | 2 ml soln to 8 ml water |
| | | | | slow gas formation |
| | | | | no continued gassing |
| | | | | deposits remain after |
| | | | | 10 min cylinder white |
| | | | | after 20 min |

Table 5 demonstrates the results of a solution comprising persuccinic acid produced by reacting 3.0 gm sodium percarbonate with 3.0 gm succinic anhydride in 50 ml of water for 30 minutes followed by dilution with another 50 ml of water. The final dilutions used to treat the ceramic cylinder provided a higher concentration of actives than for the examples of biocide solutions of the invention illustrated in tables 1 and 3. The persuccinic acid did not demonstrate the ability to decompose the proteinaceous deposits at a rate comparable to the composition of the invention.

TABLE 6

| Sample | NaClO₃ | Percarbonate | Sequence | Observation |
|---|---|---|---|---|
| Alkaline | 1.00 gm | 2.00 gm | mixture | pH 9.8 |
| | | | | gas formation of surface |
| | | | | Slow compared to |
| | | | | Succinic anhydride |
| | | | | samples |

Table 6 shows that concentrated solutions comprising a polyoxychlorine and peroxide donor do not provide performance comparable to biocide solutions that result from composition of the invention that include succinic anhydride.

TABLE 7

| | | | | | Observation |
|---|---|---|---|---|---|
| | Sodium | Sodium | Succinic | Alkalinity | Ceramic |
| SAMPLE | Chlorate | Persulfate | Anhydride | NaHCO₃ | Cylinder test |
| #1ClO3P | 2.0 gm | 2.0 gm | 0.5 gm | 0.5 gm | pH 6.6 stock |
| | | | | | soln. 2 ml |
| | | | | | stock soln. |
| | | | | | to 8 ml |
| | | | | | wate rapid |
| | | | | | gas evolution |
| | | | | | completed in |
| | | | | | approx |
| | | | | | 4 min. |

Table 7 illustrates the results of a biocide and bleaching solution produced by the composition of the invention being contacted with water. This example included sodium persulfate to further enhance the potential for bleaching and synergistic oxidation. The biocide and bleaching solution showed excellent result on the test ceramic cylinder at approximately a 1 wt % solution.

TABLE 8

| | Sodium | Sodium | Succinic | |
|---|---|---|---|---|
| SAMPLE | Chlorate | Chlorite | Anhydride | Observation |
| ClO3ClO2 | 0.2 gm | 0.1 gm | 1.0 gm | ClO2 = 354 ppm |

Table 8 illustrates the biocide and bleach solutions resulting from the composition of the invention can also be formulated to produce chlorine dioxide by addition of an alkali or alkali earth chlorite.

TABLE 9

| | | | | | Whey |
|---|---|---|---|---|---|
| | Sodium | Sodium | Succinic | Alkalinity | protein |
| SAMPLE | Chlorate | Persulfate | Anhydride | NaHCO₃ | reactivity |
| #1ClO3P | 2.0 gm | 2.0 gm | 0.5 gm | n/a | pH 3.93 |
| | | | | | none |
| | | | | | detected |
| | | | | 0.5 gm | pH 6.65 |
| | | | | | Extremely |
| | | | | | reactive |
| | | | | | vigorous |
| | | | | | evolution of |
| | | | | | gas |

Table 9 illustrates the results of one composition of the invention showing the biocide and bleaching solution showing no significant reaction with whey protein when the pH was below 4.0. However with the addition of sodium bicarbonate, the pH was elevated to above 6.0, the result obtained with addition of whey protein was dramatically changed. The evolution of gas was vigorous. This indicates that biocide and/or bleaching solutions could be produced in advance and stored under low pH conditions until ready for use. This would be comparable for example to liquid bleach (Clorox®), where bleach is stored under alkaline conditions to improve stability.

What is claimed is:

1. A composition for producing a biocide solution upon contact with water, the composition comprising:
an acid anhydride;
a polyoxychlorine anion donor;
the polyoxychlorine anion donor comprising at least one polyoxychlorine anion having from 3 moles to 4 moles of oxygen reported as elemental oxygen; and
wherein the molar ratio of the acid anhydride to polyoxychlorine anion is about 25:1 to 1:10.

2. The composition according to claim 1, wherein the acid anhydride comprises succinic anhydride.

3. The composition according to claim 1, wherein the polyoxychlorine anion donor is selected from at least one of an alkali and alkali earth metal of chlorate and alkali and alkali earth metal of perchlorate.

4. The composition according to claim 3, wherein the polyoxychlorine anion donor is selected from at least one of sodium chlorate, potassium chlorate, calcium chlorate, magnesium chlorate, sodium perchlorate, potassium perchlorate, calcium perchlorate, magnesium perchlorate.

5. The composition according to claim 1, wherein the molar ratio of the acid anhydride to polyoxychlorine anion is about 15:1 to 1:5.

6. The composition according to claim 1, wherein the molar ratio of the acid anhydride to polyoxychlorine anion is about 10:1 to 1:2.

7. The composition according to claim 1, wherein the composition further comprises an alkali or alkali earth metal of chlorite.

8. The composition according to claim 7, wherein the chlorite is selected from at least one of sodium chlorite, potassium chlorite, calcium chlorite, and magnesium chlorite.

9. The composition according to claim 1, further comprising a hydrogen peroxide donor.

10. The composition according to claim 9, wherein the hydrogen peroxide donor is selected from at least one of sodium perborate and sodium percarbonate.

11. The composition according to claim 9, wherein the hydrogen peroxide donor is selected from at least one of sodium peroxide and hydrogen peroxide.

12. The composition according to claim 1, further comprising a persulfate donor.

13. The composition according to claim 12, wherein the persulfate donor is selected from at least one of sodium persulfate and potassium persulfate.

14. The composition according to claim 1, further comprising an alkalinity donor.

15. The composition according to claim 14, wherein the alkalinity donor is selected from at least one an alkali metal of bicarbonate, alkali metal of carbonate, alkali metal of phosphate, and alkali metal of borate.

16. The composition according to claim 1, wherein the composition is a solid composition.

17. The composition of claim 16, wherein the solid composition is in the form of a powder.

18. The composition of claim 16, wherein the solid composition is in the form of granules.

19. The composition of claim 16, wherein the solid composition is in the form of a tablet.

20. A biocide solution comprising water, and at least a 0.5 wt % of a composition comprising:
an acid anhydride;
a polyoxychlorine anion donor;
the polyoxychlorine anion donor comprising at least one polyoxychlorine anion having from 3 moles to 4 moles of oxygen reported as elemental oxygen; and
wherein the molar ratio of the acid anhydride to polyoxychlorine anion is about 25:1 to 1:10.

21. The biocide solution according to claim 20, wherein the acid anhydride comprises succinic anhydride.

22. The biocide solution according to claim 20, wherein the polyoxychlorine anion donor is selected from at least one of an alkali and alkali earth metal of chlorate and alkali and alkali earth metal of perchlorate.

23. The biocide solution according to claim 22, wherein the polyoxychlorine anion donor is selected from at least one of sodium chlorate, potassium chlorate, calcium chlorate, magnesium chlorate, sodium perchlorate, potassium perchlorate, calcium perchlorate, magnesium perchlorate.

24. The biocide solution according to claim 20, wherein the molar ratio of the acid anhydride to polyoxychlorine anion is about 15:1 to 1:5.

25. The biocide solution according to claim 20, wherein the molar ratio of the acid anhydride to polyoxychlorine anion is about 10:1 to 1:2.

26. The biocide solution according to claim 20, wherein the composition further comprises an alkali or alkali earth metal of chlorite.

27. The biocide solution according to claim 26, wherein the chlorite is selected from at least one of sodium chlorite, potassium chlorite, calcium chlorite, and magnesium chlorite.

28. The biocide solution according to claim 20, further comprising a hydrogen peroxide donor.

29. The biocide solution according to claim 28, wherein the hydrogen peroxide donor is selected from at least one of sodium perborate and sodium percarbonate.

30. The biocide solution according to claim 28, wherein the hydrogen peroxide donor is selected from at least one of sodium peroxide and hydrogen peroxide.

31. The biocide solution according to claim 20, further comprising a persulfate donor.

32. The biocide solution according to claim 31, wherein the persulfate donor is selected from at least one of sodium persulfate, potassium persulfate, and potassium monopersulfate.

33. The biocide solution according to claim 20, further comprising an alkalinity donor.

34. The biocide solution according to claim 33, wherein the alkalinity donor is selected from at least one an alkali metal of bicarbonate, alkali metal of carbonate, alkali metal of phosphate, and alkali metal of borate.

35. A method of killing microorganisms comprising:
forming a biocide solution by adding water to a composition comprising:
an acid anhydride;
a polyoxychlorine anion donor;
the polyoxychlorine anion donor comprising at least one polyoxychlorine anion having from 3 moles to 4 moles of oxygen reported as elemental oxygen; and
wherein the molar ratio of the acid anhydride to polyoxychlorine anion is about 25:1 to 1:10.

36. The method according to claim 35, wherein the acid anhydride comprises succinic anhydride.

37. The method according to claim 35, wherein the polyoxychlorine anion donor is selected from at least one of an alkali and alkali earth metal of chlorate and alkali and alkali earth metal of perchlorate.

38. The method according to claim 37, wherein the polyoxychlorine anion donor is selected from at least one of sodium chlorate, potassium chlorate, calcium chlorate, magnesium chlorate, sodium perchlorate, potassium perchlorate, calcium perchlorate, magnesium perchlorate.

39. The method according to claim 35, wherein the molar ratio of the acid anhydride to polyoxychlorine anion is about 15:1 to 1:5.

40. The method according to claim 35, wherein the molar ratio of the acid anhydride to polyoxychlorine anion is about 10:1 to 1:2.

41. The method according to claim 35, wherein the composition further comprises an alkali or alkali earth metal of chlorite.

42. The method according to claim 41, wherein the chlorite is selected from at least one of sodium chlorite, potassium chlorite, calcium chlorite, and magnesium chlorite.

43. The method according to claim 35, further comprising a hydrogen peroxide donor.

44. The method according to claim 43, wherein the hydrogen peroxide donor is selected from at least one of sodium perborate and sodium percarbonate.

45. The method according to claim 43, wherein the hydrogen peroxide donor is selected from at least one of sodium peroxide and hydrogen peroxide.

46. The method according to claim 35, further comprising a persulfate donor.

47. The method according to claim 46, wherein the persulfate donor is selected from at least one of sodium persulfate, potassium persulfate, and potassium monopersulfate.

48. The method according to claim 35, further comprising an alkalinity donor.

49. The method according to claim 48, wherein the alkalinity donor is selected from at least one an alkali metal of bicarbonate, alkali metal of carbonate, alkali metal of phosphate, and alkali metal of borate.
